(19) United States
(12) Patent Application Publication
(10) Pub. No.: US 2008/0209779 A1
(43) Pub. Date: Sep. 4, 2008

(54) Greeting Label

(76) Inventors: Sharon Mirande, West Chester, OH (US); Stephen Mirande, West Chester, OH (US)

Correspondence Address: HASSE & NESBITT LLC, 8837 CHAPEL SQUARE DRIVE, SUITE C, CINCINNATI, OH, 45249, US

(21) Appl. No.: 11/859,037

(22) Filed: Sep. 21, 2007

Related U.S. Application Data
(60) Provisional application No. 60/890,552, filed on Feb. 19, 2007.

(51) Int. Cl. G09F 3/00; G09F 3/10

(52) U.S. Cl. 40/310; 40/299.01

(57) ABSTRACT

A greeting label for placement over the original label of a bottle, such as a bottle of wine or champagne. The label typically has an adhesive on the back face and indicia such as a greeting and a decorative design on the front face. A removable panel typically is adhered to the back face prior to use and then removed so that the adhesive is exposed prior to applying the label to the bottle. The greeting label may be pre-packaged as a kit, and can include a plurality of decorative labels for placing on the bottle.

### FIELD OF THE INVENTION

The present invention relates generally to labels, and more particularly to a greeting label for bottles, such as wine bottles.

### BACKGROUND OF THE INVENTION

Greeting cards are well known in the art. Such cards are tailored for a particular occasion, i.e., birthday, wedding, graduation, and can be further classified into various subcategories i.e., son, daughter, cousin, parent, grandparent, and so forth. When a gift is given, it is customary to wrap the gift and attach a card. An unwrapped gift may imply that the gift was purchased at the last minute, or may convey insensitivity in that the donor is unwilling to go through the effort of wrapping the gift. An attached card allows the donor to express a personalized message to the recipient, and also provides a practical way of identifying who gave the gift.

Despite the voluminous amount of cards presently available, there exists a market of consumers who desire a type of greeting card that can be adhered to another object in the form of a label. For example, U.S. Pat. No. 5,102,171 describes a greeting card having a peel-off sheet formed of static cling vinyl on which an image is printed. This sheet may be attached by electrostatic attraction to a non-porous surface. Also, U.S. Pat. No. 5,284,365 describes a greeting card having a cut out containing a removable message section that can be removed from the basic greeting card, and by means of adhesive or magnetic material, applied to a surface. U.S. Pat. Nos. 7,021,666 and 5,951,057 disclose heat-transferable greeting cards with portions that can be transferred on to clothing.

Traditionally, it has been difficult to attach a greeting message or announcement to a bottle, such as a wine bottle, and people have resorted to the use of sticky tape, etc, which is inconvenient. Devices for carrying messages on bottles often have a complex structure, and have been expensive, or fragile, or both. For example, published U.S. Patent Application No. 2005/0229450 discloses an attachable wrap for bottles. The wrap is intended to be placed around the cylinder of the bottle, and includes a “window” so that the original label is still visible.

While these prior art products may be useful for their intended purposes, there still exists a need for a gift label for a bottle that is easy to apply to the original label of the bottle, and is easily removable from the bottle without damage to the original label.

### SUMMARY OF THE INVENTION

The present invention generally provides a label for covering the original label of a bottle that is being given as a gift. When a person purchases a bottle of wine, champagne, etc, as a gift, the person also attaches the greeting label, which carries an appropriate message in a well-presented manner, such as will supplement and enhance the gift. Although the invention is intended particularly for use with bottles, and is intended to be made available for sale in wine shops, gift shops and on the Internet, the device may also be used for other articles of appropriate shape.

More specifically, one aspect of the invention provides a greeting label for placing over the original label of a bottle, comprising a front face for displaying information or decoration; a back face; and a coating of adhesive applied to the back face, wherein the label is adapted to be placed over the original label of the bottle so that the front face is visible and the adhesive affixes the back face to the bottle. Typically the label also includes a removable panel that is fully detachable from the adhesive portion of the back face.

Another aspect of the invention provides a kit for placing greeting labels on a bottle, comprising a plurality of labels, each label including a front face for displaying information or decoration, a back face, and a coating of adhesive applied to the back face; a removable panel for covering the back faces of the plurality of labels prior to use, wherein the panel is fully detachable from the adhesive; and directions for placing the labels on a bottle, wherein at least one of the plurality of labels is adapted to be placed over the original label of a bottle so that the front face is visible and the adhesive affixes the back face to the bottle.

A third aspect of the invention provides a greeting label for use with a wine bottle, comprising a substrate including a front face and a back face; indicia printed on the front face for displaying information or decoration; a coating of adhesive disposed on the back face of the substrate for adhering to a wine bottle; and a removable panel which is fully detachable from the adhesive.

The nature and advantages of the present invention will be more fully appreciated from the following drawings, detailed description and claims.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 is a perspective view of one embodiment of the label of the present invention.

FIG. 2 is a side cross-sectional view of the label 10 of FIG. 1

FIG. 3 is a perspective view of kit including the label of the invention, as it can appear in its packaging.

FIG. 4 is a perspective view of the labels in the kit of FIG. 3 as they look applied to a wine bottle.

### DETAILED DESCRIPTION OF THE INVENTION

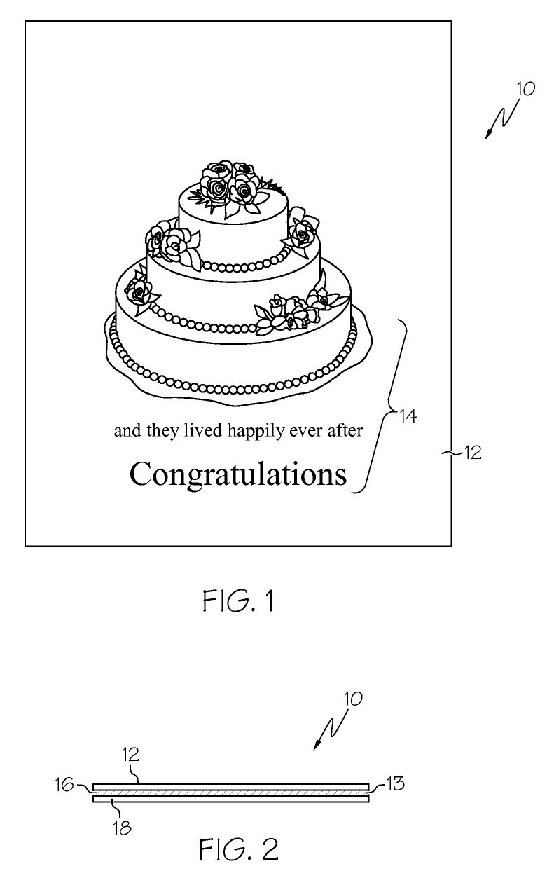

Referring now to the figures, the greeting label according to the present invention is generally identified by the numeral 10. FIG. 1 shows one embodiment of the label 10 of the invention, with the front face 12 having indicia capable of displaying information or decoration 14 in the form of a greeting card. The indicia 14 are typically printed by the manufacturer of the labels. However, in other embodiments of the invention, the front face 12 of the label can have a blank space for the gift-giver to write a personal message or sketch a drawing.

FIG. 2 shows a side cross-sectional view of the label of FIG. 1, illustrating that the label is a substrate 10 having a front face 12 with an adhesive coating 16 substantially completely covering the back face 13, and a removable panel 18 which is typically fully detachable from the adhesive coating 16. Typically the removable panel 18 can gently adhere to the adhesive coating 16 but is readily removable prior to applying the label to the bottle, so that the adhesive coating is exposed and ready to stick to the bottle.

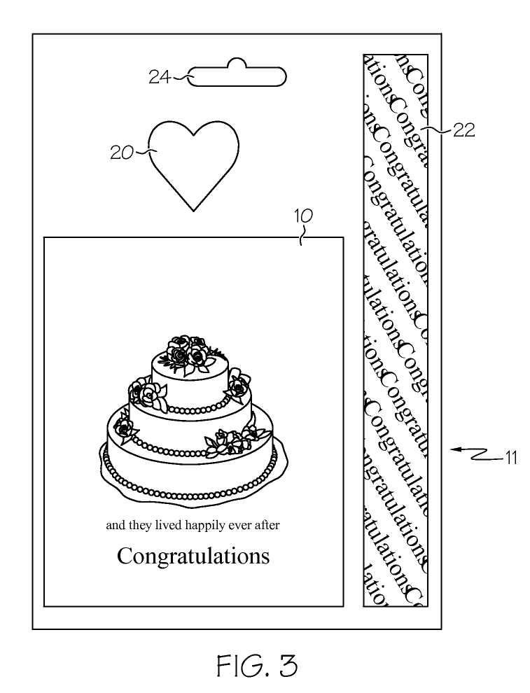

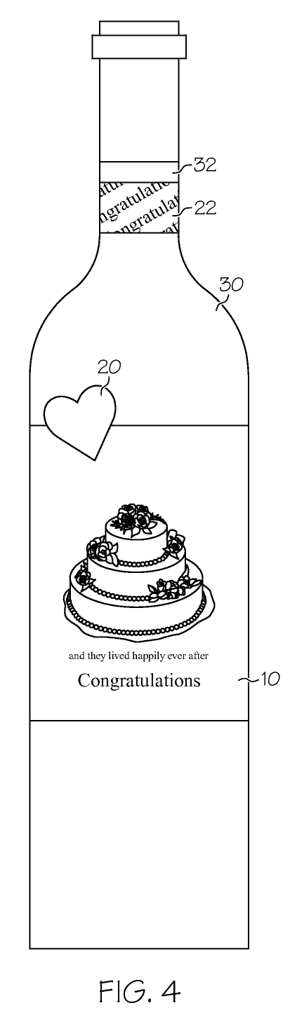

FIG. 3 shows a kit of the invention in the form of packaging 11 with a plurality of labels 10, 20, 22 enclosed inside. The kit package 11 includes a perforation or hole 24 for hanging the package on a small rod, like those seen at check-out lanes in grocery stores. Label 10 is the greeting label of FIG. 1 and is intended to cover the original label of the bottle, while labels 20 and 22 are not intended to cover the original label of the bottle. As illustrated, label 20 is a heart-shaped label and label 22 is a strip-shaped label; however, labels 20, 22 arc not limited to the shapes shown, and can be a plurality of smaller decorative labels for placing on the cylinder and neck of the bottle, in any shape desired by the manufacturer that will appeal to consumers. The package also includes directions for placing the labels on the bottle, and each of the labels has a front face and a back face, an adhesive coating applied to the back face, and a removable panel attached to the adhesive, as explained above. Typically the package 11 includes at least one of the labels being of the type 10 illustrated in FIGS. 1 and 4.

FIG. 4 illustrates the removable labels 10, 20 and 22 of FIG. 3 after they have been placed on a wine bottle 30. Label 10 is typically placed over the original label of the bottle 30 so that the front face is visible and the adhesive portion removably affixes the back face to the bottle. Further, the heart-shaped label 20 can typically be affixed anywhere on the cylinder of the bottle 30, and the strip-shaped label 22 is typically placed around the neck 32 of the bottle.

The adhesive coating 16 used on the labels of the invention typically includes a mild, pressure-sensitive, repositionable adhesive which will permit the removal or repositioning of the label or substrate from the surface of the original label on the bottle, without removing the original label or leaving adhesive or staining behind upon removal. As a non-limiting example, adhesives disclosed in U.S. Pat. No. 3,691,140 to Silver or U.S. Pat. No. 4,735,837 to Miyasaka et al can be used. However, a permanent adhesive or glue may also be used, or the adhesive can be a pressure-sensitive adhesive wax or other binder that is sticky, tacky and non-hardening, as is known in the art. The removable panel of the invention can be a non-adhesive backing strip, for example a release paper, which may be peeled away by the user prior to use.

While the present invention has been illustrated by the description of embodiments and examples thereof, it is not intended to restrict or in any way limit the scope of the appended claims to such detail. Additional advantages and modifications will be readily apparent to those skilled in the art. Accordingly, departures may be made from such details without departing from the scope or spirit of the invention.

What is claimed is:

1. A greeting label for placing over the original label of a bottle, comprising:
a front face for displaying information or decoration;
a back face; and
a coating of adhesive applied to the back face, wherein the label is adapted to be placed over the original label of the bottle so that the front face is visible and the adhesive affixes the back face to the bottle.

2. The label of claim 1, further including a removable panel for covering the back face prior to use, wherein the panel is fully detachable from the coating of adhesive.

3. The label of claim 1, wherein the front face includes a blank space for writing a personal message or for sketching a drawing.

4. The label of claim 1, wherein the adhesive is a repositionable adhesive.

5. The label of claim 1, wherein the adhesive is a permanent adhesive.

6. A kit for placing greeting labels on a bottle, comprising:
a plurality of labels, each label including a front face for displaying information or decoration, a back face, and a coating of adhesive applied to the back face;
a removable panel for covering the back faces of the plurality of labels prior to use, wherein the panel is fully detachable from the adhesive; and
directions for placing the labels on a bottle,
wherein at least one of the plurality of labels is adapted to be placed over the original label of a bottle so that the front face is visible and the adhesive affixes the back face to the bottle.

7. The kit of claim 6, wherein the adhesive is a repositionable adhesive.

8. The label of claim 6, wherein the adhesive is a permanent adhesive.

9. A greeting label for use with a wine bottle, comprising;
a substrate including a front face and a back face;
indicia printed on the front face for displaying information or decoration;
a coating of adhesive disposed on the back face of the substrate for adhering to a wine bottle; and
a removable panel which is fully detachable from the adhesive.

10. The greeting label of claim 9, wherein the coating substantially completely covers the back face.

11. The greeting label of claim 9, wherein the adhesive is a repositionable adhesive, such that the label is adapted to adhere to the bottle until positively removed by a removal force.

12. The greeting label of claim 9, wherein the adhesive is a permanent adhesive

13. The greeting label of claim 9, wherein the label is part of a kit including a plurality of labels and directions for placing the labels on a bottle, wherein at least one of the plurality of labels is adapted to be placed over the original label of a bottle so that the front face is visible and the adhesive affixes the back face to the bottle.
